(19) United States
(12) Patent Application Publication
(10) Pub. No.: US 2009/0281190 A1
(43) Pub. Date: Nov. 12, 2009

(54) NOVEL ATTRACT AND KILL COMPOSITION FOR CONTROL OF PEST INSECTS

(75) Inventors: Grigori Khaskin, Coquitlam (CA); Regine Gries, Coquitlam (CA); Emma Rozenberg, Coquitlam (CA); Hassan Daroogheh, West Vancouver (CA); Lucian Mircioiu, New Westminster (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Simon Fraser University, Burnaby, BC (CA)

(21) Appl. No.: 12/296,762

(22) PCT Filed: Apr. 13, 2006
(86) PCT No.: PCT/CA2006/000594

§ 371 Date: Mar. 2, 2009

(51) Int. Cl. A01N 37/10; A01P 7/00; A01P 7/02; A01P 7/04

(52) U.S. Cl. 514/570

(57) ABSTRACT

The invention relates to a composition and procedure to attract and kill insect pests. An insecticidal attract-and-kill composition comprising: an organic biodegradable matrix component from natural sources; an organic biodegradable ultraviolet light absorbent matrix component from natural sources; a biodegradable insecticidal or acaricidal compound; and a pheromonal or kairomonal attractant.

### FIELD OF THE INVENTION

The invention relates to a composition and procedure to attract and kill insect pests.

### BACKGROUND OF THE INVENTION

A variety of approaches have been developed that use synthetic pheromone of target insects for their effective management in tree fruit and nut crops. These approaches include a) chopped hollow fibres, or flakes, loaded with pheromone in hand-applied or sprayable formulations (1-3); b) application of hand-applied pheromone dispensers (4); c) sprayable microencapsulated pheromone (5-8); d) widely spaced aerosol pheromone emitters (9) or Metered Semiochemical Release Systems (10); and e) attracticidal paste droplet impregnated with pheromone and laced with insecticide (11).

Compared to pheromone technologies a-d, attract and kill (A&K) formulations (e) are advantageous in that they i) require relatively little pheromone; ii) allow incorporation of food semiochemicals to enhance pheromonal attractiveness; iii) kill or incapacitate insects that have contacted paste droplets (thus preventing continued chance encounters of potential mates); and iv) require no expensive application equipment.

Two international companies, Bayer (Germany) and Novartis (Switzerland), have invented and patented A&K formulations for insect control (12, 13). The Bayer A&K formulation disclosed and claimed in U.S. Pat. No. 5,707,638 comprises a) 0.1-10% by weight of insecticidal cyflutrin, beta-cyflutrin or transfluthrin; b) 0.01-1% of a pheromone substance; c) 10-90% of a polyvinyl acetate; d) 10-80% of a UV absorber selected from a benzotriazole, 2-hydroxy-4-methoxy-benzophenone, and 2-(2-ethyl-hexyl)-2-cyano-3,3-diphenyl-2-propenoate; and f) 0.1-4% by weight of a surfactant and water.

The Novartis A&K formulation disclosed and claimed in U.S. Pat. No. 5,759,561 contains a) 0.01-30% by weight of a pheromone or kairomone; b) 0.1-10% of a pesticide; and c) 51-98% of a UV absorber selected from a group consisting of 2-H-benzotriazoles, 2-hydroxy-alkoxy-benzophenones, oxalanilides, cinnamic acid esters and triazines.

Extensive multi-year field trials conducted by Novartis and the licensee IPM Technologies (Portland, Oreg.) have purportedly demonstrated that “their” A&K formulation can control insect pests to the same extent as the most effective pesticide on the market (14-21).

A&K formulations have been successfully tested for control of moths, fruit flies, beetles, and ticks. They are registered for control of codling moth, Cydia pomonella, pink bollworm, Pectinophora gossypiella, false codling moth, Cryptophlebia leucotreta, Oriental Fruit Moth, Grapholita molesta, Macadamia nutborer, Cryptophiebia ombrodelta, and western pine shootborer, Eucosma sonomana.

### SUMMARY OF THE INVENTION

The A&K formulation according to the invention consists of a) gelled Castor oil (30-80% by weight) [Ricinus communis (castor) seed oil, glycine soja (soybean) germ extract, Zea maize (corn) starch, and silica]; b) lignin (5-80%) (e.g. Indulin AT) as a UV absorber and matrix component; c) insecticidal permethrin (0.1-10%) (e.g. Everside 2203); and d) attractive pheromone or kairomone (0.1-20%) in organic solvent.

The essence of the invention is the preparation and deployment in the field of paste droplets containing the composition to attract and kill insect pests.

Ingredients of the A&K composition can be formulated in all possible proportions and ratios. The compositions can be placed on plants or any other suitable surface to attract and kill pest insects.

The invention is directed to a completely biodegradable insect control composition technology that contains only organic ingredients and inert silica.

The invention is also directed to the use of lignin as a composition ingredient that is highly effective in protecting insecticides and pheromones (or other semiochemicals) from degradation by UV light.

The invention also pertains to a process by which droplets of the composition are placed by hand-held applicators or automated devices on any type of suitable surface to attract and kill insect pests.

The invention is directed to an insecticidal attract-and-kill composition comprising: (a) gelled castor oil (30-80% by weight) as a matrix component; (b) lignin (5-80% by weight) as a matrix component and absorbent of ultraviolet light; (c) an insecticidal or an acaricidal compound (0.1-10% by weight); and (d) a pheromonal or kairomonal attractant in organic solvent (0.1-20% by weight), the respective components and compounds totaling 100 percent.

The gelled castor oil component (a) can be replaced with an oil selected from the group consisting of gelled canola oil, gelled soybean oil, gelled hydrogenated vegetable oil, gelled rice bran oil, gelled sunflower oil, gelled flax seed oil, gelled palm oil, gelled hemp seed oil, gelled grape seed oil, gelled safflower oil, and any other suitable plant-derived oil.

The lignin component (b) can be selected from the group consisting of different grades of modified and unmodified lignins.

The insecticidal component (c) can be selected from the group consisting of permethrin and other contact insecticides.

The attractive pheromone or kairomone component (d) can be selected from the group consisting of compounds that attract insects, spiders, mites, or other target organisms.

The composition might not contain an insecticidal or an acaricidal compound (c). Instead of an attractant (d), it may contain a repellent.

The invention is also directed to a method of controlling harmful insects, ticks, mites or spiders by distributing in the area to be protected an effective amount of the composition according to the invention. The area to be protected may be an agricultural, horticultural, forestry or nursery setting, a livestock production facility, or an urban or recreational environment.

The composition may be used in combination with other tactics for control of pest insects or arachnids. The composition may be used in the attraction or kill of insect pests.

### DRAWINGS

Exemplary embodiments are illustrated in referenced figures of the drawings. It is intended that the embodiments and figures disclosed herein are to be considered illustrative rather than restrictive.

FIG. 1 illustrates graphical data of the amounts of codlemone in experiment 1 released from ten 50-mg droplets of the composition during 1-88 days. Droplets were aged under UV light in the laboratory at 24-30° C. All data points are the mean of three replicates.

FIG. 2 illustrates graphical data of captures of male Cydia pomonella in wind tunnel experiments 2-6 with sticky traps baited with a single droplet of the composition aged under UV-light for 0-8 days (Exp. 2; 8 replicates, droplet weight: 5 mg), 21-28 days (Exp. 3; 8 replicates, droplet weight: 5 mg), 42-46 days (Exp. 4; 5 replicates, droplet weight: 12.5 mg), 63-67 days (Exp. 5; droplet weight: 25 mg) and 84-88 days (Exp. 6; 5 replicates, droplet weight: 25 mg). In each experiment, an asterisk (*) indicates a statistically significant difference; t-test, α=0.05.

FIG. 3 illustrates graphical data of numbers of male Cydia pomonella exposed in experiments 7-11 to a 50-mg droplet of the composition, or to a 50-mg droplet lacking insecticidal permethrin. In each experiment, an asterisk (*) indicates a statistically significant difference; t-test, α=0.05.

FIG. 4 illustrates graphical data of captures of male Kermania pistaciella in 4-day-intervals in experiment 12 (near Mafoon, Iran) in sticky traps baited with (2S,12Z)-2-acetoxy-12-heptadecene (50 μg). Each data point represents the mean number (±standard error) of males captured in the 20 traps (four in each of five plots) assigned to a particular treatment (A&K, insecticide, or control).

FIG. 5 illustrates graphical data of proportions of damaged fruit bunches per tree in plots treated with the A&K composition, insecticide or left untreated. In combined results of replicates 1-5 (depicted on the right side of the drawing), bars with different letter superscripts are significantly different. For statistical analyses, data were transformed by arcsin and subjected to Analysis of Variance followed by Student-Newman-Keuls test for comparison of means (24). Untransformed data are presented.

FIG. 6 illustrates graphical data of captures of male Kermania pistaciella in 4-day intervals in experiment 12 (near Chatrood, Iran) in sticky traps baited with (2S,12Z)-2-acetoxy-12-heptadecene (50 μg). Each data point represents the mean number (+/−standard error) of males captured in the 15 traps (3 in each of five plots) assigned to a particular treatment (A&K, insecticide, or control).

FIG. 7 illustrates graphical data of proportions of damaged fruit bunches per tree in plots treated with the A&K composition, insecticide, or left untreated. In combined results of replicates 1-5 (depicted on the right side of the drawing), bars with different letter superscripts are significantly different. For statistical analyses, data were transformed by arcsin and subjected to Analysis of Variance followed by Student-Newman-Keuls test for comparison of means (24). Untransformed data are presented.

FIG. 8 illustrates graphical data of captures of male Cydia pomonella in experiment 14 in sticky traps baited with synthetic (E,E)-8,10-dodecadien-1-ol (50 μg). Commercial apple orchard near Caseiu, Cluj county, Romania; five 2-trap replicates. The asterisk (*) indicates significantly higher captures in plots treated with insecticide; t-test (24), P<0.05.

FIG. 9 illustrates graphical data of the mean proportion of apples damaged by Cydia pomonella larvae in five 1-hectare plots treated with insecticide or the A&K composition. Apple orchard near Caseiu, Cluj county, Romania. The mean proportion of damaged apples in both treatments was not statistically different; t-test, P>0.05.

### DETAILED DESCRIPTION OF THE INVENTION

Pheromone Release Rates, Attractiveness, and Killing Potency Over Time.

Fifty-milligram droplets of the composition containing 0.2% of (E,E)-8,10-dodecadienol (termed “codlemone”, sex pheromone of codling moth, Cydia pomonella), and 6% of insecticidal permethrin were UV-light exposed at 24-30° C., and tested every day during days 0-16, 21-30, 42-46, 63-67 and 84-88 for pheromone release rates (Experiment 1), attractiveness (Experiments 2-6), and killing potency (Experiments 7-11).

To determine release rates of codlemone, ten 50-mg droplets of the composition in each of 3 replicates per test day (see above) were placed in 3 separate Pyrex glass chambers (15.5 cm inner diameter×20 cm high). A water aspirator drew charcoal-filtered air at 1000 ml per minute through the chamber and a glass column (100×5 mm) filled with Porapak Q. After 24 hours of codlemone capture, Porapak Q traps were eluted with pentane and aliquots of extracts were analyzed by gas chromatography, employing a Hewlett Packard 5890 GC equipped with a GC column (30 m×0.25 mm ID) coated with DB-5.

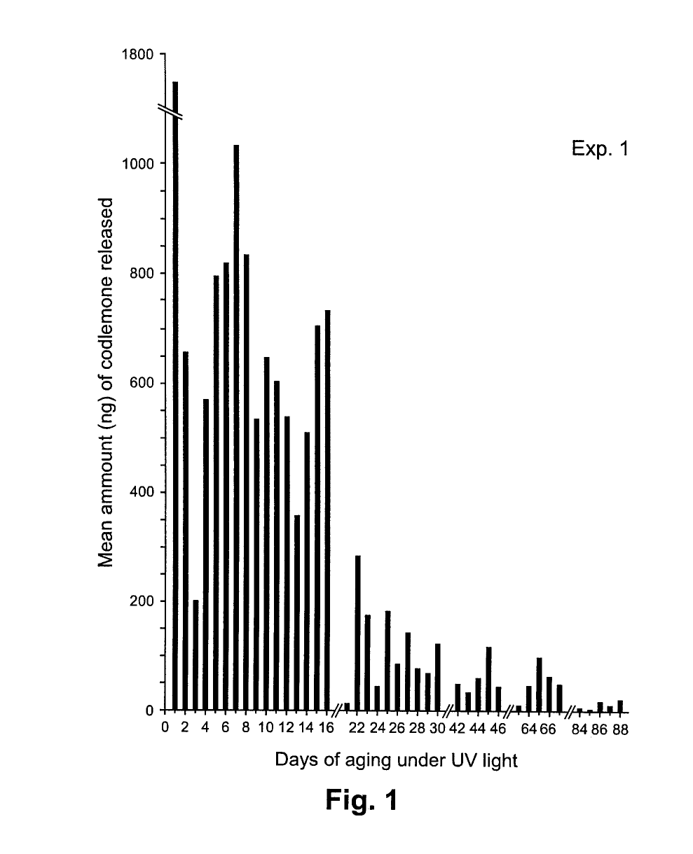

These GC analyses revealed that the largest amounts of codlemone were released during the first 16 days. There were also significant amounts of codlemone released during days 21-30, 42-46, 63-67, and even days 84-88 (FIG. 1).

FIG. 1 illustrates graphical data of the amounts of codlemone in experiment 1 released from ten 50-mg droplets of the composition during 1-88 days. All data points are the mean of three replicates.

To determine whether droplets of the composition after continued exposure to Uv-light (see above) remain attractive to male Cydia pomonella, wind tunnel experiments were conducted. In each replicate, at dusk (20:00 hours) 10 male Cydia pomonella were released into a wind tunnel with an air flow of 30 cm per second. At the up-wind end of the tunnel, two sticky 2-L milk carton traps (22) were placed 50 cm above floor level and 60 cm apart from each other, with the treatment stimulus (one droplet of the composition) or control stimulus (no droplet of the composition) randomly assigned to each trap. Eight hours after the males were released, captures in each trap were recorded. Experiments 2, 3, 4, 5 and 6, respectively, tested the attractiveness of a single droplet aged under UV-light (F20T 12-BL, Black Light, 20 Watt, General Electric, USA; light position: 40 cm above droplets; photoperiod: 16 hours light, 8 hours dark) 0-8 days (Exp. 2; droplet weight: 5 mg), 21-28 (Exp. 3; droplet weight: 5 mg), 42-46 days (Exp. 4, droplet weight: 12.5 mg), 63-67 days (Exp. 5; droplet weight: 25 mg), and 84-88 days (Exp. 6; droplet weight: 25 mg).

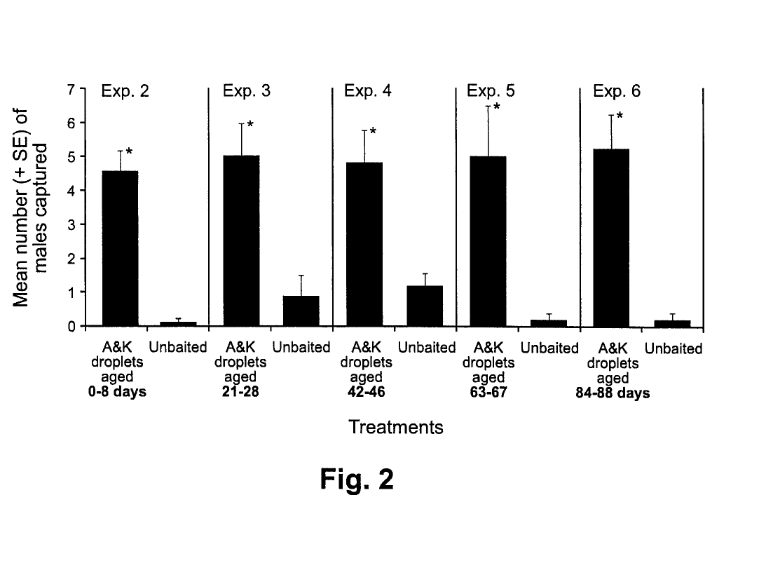

Freshly prepared droplets (Exp. 2), and droplets aged under UV-light 21-88 days (Exps. 3-6) all attracted significantly more male Cydia pomonella than did unbaited control traps (FIG. 2). Moreover, droplet attractiveness remained constant irrespective of the length of the UV-light exposure period.

FIG. 2 illustrates graphical data of captures of male Cydia pomonella in wind tunnel experiments 2-6 with sticky traps baited with a single droplet of the composition aged under UV-light for 0-8 days (Exp. 2; 8 replicates, droplet weight: 5 mg), 21-28 days (Exp. 3; 8 replicates, droplet weight: 5 mg), 42-46 days (Exp. 4; 5 replicates, droplet weight: 12.5 mg), 63-67 days (Exp. 5; droplet weight: 25 mg) and 84-88 days (Exp. 6; 5 replicates, droplet weight: 25 mg). In each experiment, an asterisk (*) indicates a statistically significant difference; t-test, α=0.05.

To determine whether droplets of the composition after continued exposure to UV-light (see above) remain lethal to attracted male Cydia pomonella, toxicity experiments were conducted. Each replicate of experiments 7-11 employed two 4-L plastic containers with mesh-secured sides and lids. Treatment containers received one 50-mg droplet of the composition, whereas control containers received one 50-mg droplet lacking the insecticidal permethrin. Both containers were kept 120 cm apart from one another in outdoor shelters. At 20:00 hours, 10 male Cydia pomonella were placed into each container, and eight hours later numbers of dead male moths in each container were recorded.

Experiments 7, 8, 9, 10 and 11, respectively, tested the killing potency of 50-mg droplets aged under UV-light 0-8 days (Exp. 7) 21-27 days (Exp. 8), 42-46 days (Exp. 9), 63-67 days (Exp. 10), and 84-88 days (Exp. 11).

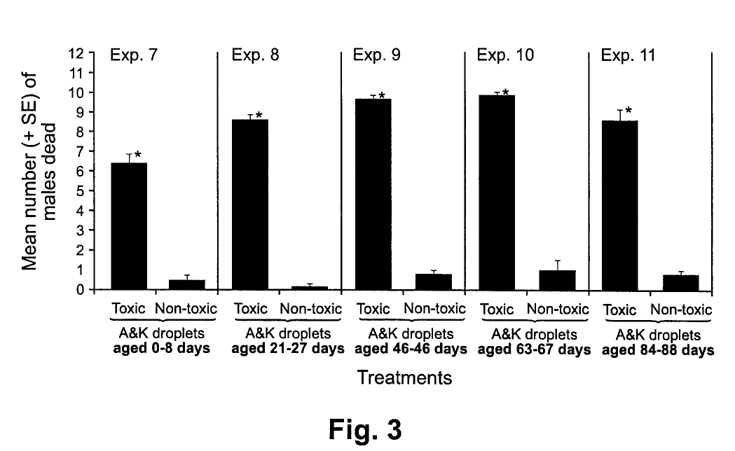

Freshly prepared droplets of the composition (Exp. 7), and droplets aged under UV-light 21-88 days (Exp. 8-11), all were effective in killing attracted male Cydia pomonella. Moreover, the killing potency of the composition remained constant irrespective of the length of the UV-light exposure period. Control droplets lacking insecticidal permethrin in experiments 7-11 did not cause significant mortality (FIG. 3).

FIG. 3 illustrates graphical data of numbers of male Cydia pomonella exposed in experiments 7-11 to a 50-mg droplet of the composition, or to a 50-mg droplet lacking insecticidal permethrin. In each experiment, an asterisk (*) indicates a statistically significant difference; t-test, α=0.05.

Moreover, recordings of male Cydia pomonella in wind tunnel bioassays revealed that the males made physical contact with droplets of the composition and died subsequently.

The (Brookfield) viscosity of the droplets was measured as follows: 912,500 cps±10% (RVT T-F, @4 rpm, 25° C.); 928,200 cps±10% (RVT T-F, @ 0.6 rpm, 25° C.); 868,140 cps±10% (RVT T-F, @0.6 rpm, 25° C.).

None of 50 droplets placed on trees on 19 Nov. 2002 and checked weekly until 28 May 2003 were washed off trees in Coquitlam, British Columbia (BC), Canada, despite heavy rainfall throughout the mild winter and spring of British Columbia.

The specific A&K composition that was tested in experiments 1-11 is only one possible composition. Many modifications, permutations, additions and sub-combinations thereof are possible, as follows:

Gelled castor oil as a matrix component (a) can be replaced with an oil selected from the group consisting of gelled canola oil, gelled soybean oil, gelled hydrogenated vegetable oil, gelled palm oil, gelled rice bran oil, gelled sunflower oil, gelled flax seed oil, gelled hemp seed oil, gelled grape seed oil, gelled safflower oil, and any other suitable plant-derived oil.

Lignin as a matrix component and absorbent of ultraviolet light (b) can be replaced and selected from the group consisting of different grades of modified and unmodified lignins.

The insecticidal component permethrin (c) can be replaced and selected from the group of insecticides consisting of pyrethroids, carbamates, organophosphates, aliphatic derivatives, phenyl derivatives, heterocyclic derivatives, neonicotinoids, phenylpyrazoles, pyrroles, pyrazoles, pyridazinones, botanicals, and mineral oils.

The pheromone component codlemone (d) can be replaced and selected from the group consisting of other insect, mite, and spider pheromones or kairomones.

Pheromones may be formulated in an organic solvent selected from the group consisting of polar, non-polar, protonic, and aprotonic solvents.

Ability of the A&K Composition to Reduce Crop Damage Caused by Larvae of the Pistachio Twig Borer Moth, Kermania pistaciella, in Pistachio Orchards, or Caused by larvae of the Codling Moth, Cydia pomonella, in Apple Orchards

To test the ability of the A&K composition to control pest insect populations and reduce crop damage caused by them, field experiments were conducted in Iran and Romania.

### EXAMPLE #1

Experiment 12 was conducted in pistachio orchards near Mafoon, Iran. Trees were 25 years old and had been planted at a density of 262 trees per hectare, with 3-m spacing between trees and 10-m spacing between rows. The experiment had five replicates, and each replicate had three treatments, as follows: (a) application of the A&K composition (2 hectares); (b) application of insecticide (2 hectares); and (c) untreated control (2 hectares). The A&K composition contained 0.2% of (2S,12Z)-2-acetoxy-12-heptadecene, the sex pheromone of Kermania pistaciella. Reference is made to PCT/CA2006/000059, filed 16 Jan. 2006, title “Composition of Chemicals for Manipulating the Behaviour of the Pistachio Twig Borer, Kermania pistaciella”. All plots were separated by 50 m. In A&K treatment plots, each tree received six to eight 50-mg droplets of the A&K composition on 7 Mar. 2005. In insecticide treatment plots, insecticide (Endosulfan plus Volt Oil) was applied on 15 Apr. 2005. Control plots received neither A&K nor insecticide applications.

To monitor population densities of Kermania pistaciella in all plots, four sticky 2-L milk carton traps (22) per 2-hectare plot were suspended from trees at a height of 1.5-2 m and spaced 50 m apart. Traps were baited with a gray sleeve stopper (23) impregnated with synthetic pheromone of Kermania pistaciella [(2S,12Z)-2-acetoxy-12-heptadecene (50 μg)]. Every four days from 7 Mar. to 10 May 2005, the numbers of male Kermania pistachiella captured in each trap were recorded.

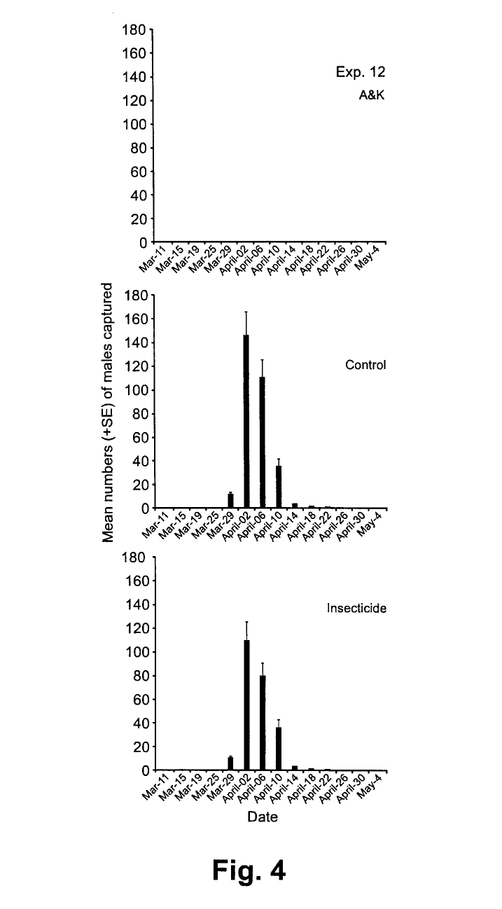

Captures of males in A&K treatment plots were significantly lower than captures in insecticide-treated or control plots (FIG. 4), suggesting that males in A&K plots contacted A&K droplets and died before they could enter traps.

FIG. 4 illustrates graphical data of captures of male Kermania pistaciella in 4-day-intervals in experiment 12 (near Mafoon, Iran) in sticky traps baited with (2S,12Z)-2-acetoxy-12-heptadecene (50 μg). Each data point represents the mean number (±standard error) of males captured in the 20 traps (four in each of five plots) assigned to a particular treatment (A&K, insecticide, or control).

To determine the ability of the A&K technology to reduce fruit bunch damage caused by larvae of Kermania pistachiella, crop damage assessments were initiated on 11 Sep. 2005 (during the harvest of pistachio nuts). In each of all fifteen 2-hectare treatment plots, 25 trees were selected randomly in the center of each plot. All fruit bunches of each selected tree were removed, counted, and checked for the presence of a Kermania pistaciella larva by breaking the stem of the fruit bunch. Then, the proportion of damaged fruit bunches per tree was calculated.

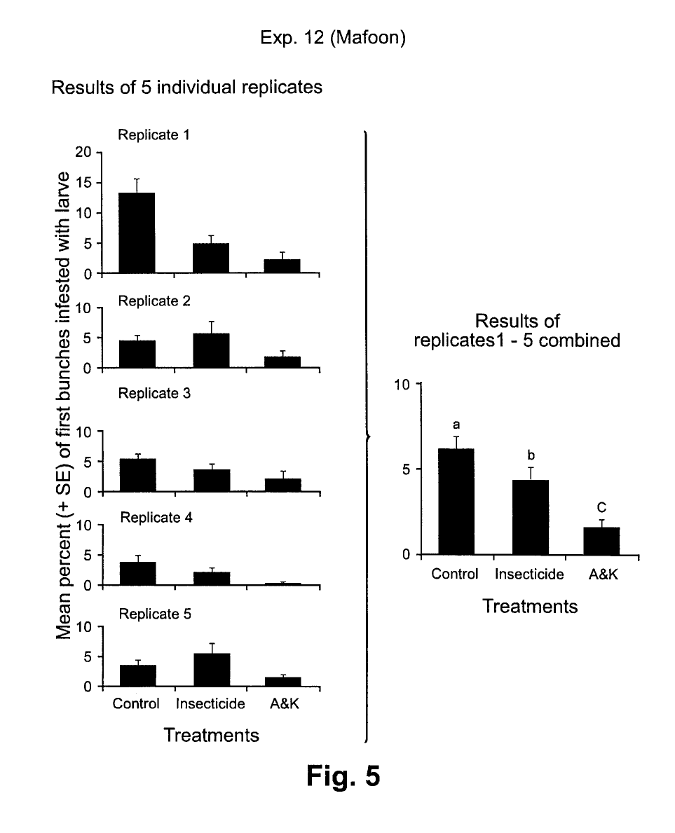

In each of all five 2-hectare A&K treatment plots, the proportions of fruit bunches per tree infested with a larva were lower than those in insecticide treatment plots or control plots (FIG. 5).

FIG. 5 illustrates graphical data of proportions of damaged fruit bunches per tree in plots treated with the A&K composition, insecticide or left untreated. In combined results of replicates 1-5, bars with different letter superscripts are significantly different. For statistical analyses, data were transformed by arcsin and subjected to Analysis of Variance followed by the Student-Newman-Keuls test for comparison of means (24). Untransformed data are presented.

### EXAMPLE #2

Experiment 13 was conducted in pistachio orchards near Chatrood, Iran. Trees were 25-30 years old and had been planted at a density of 629 trees per hectare, with 3-m spacing between trees and 6.5-m spacing between rows. The design of experiment 13 was identical to that of experiment 12. There were five replicates, and each had three treatments, as follows: (a) application of the A&K composition (2 hectares), (b) application of insecticide (2 hectares); and (c) untreated control (2 hectares). In A&K treatment plots, each tree received six to eight 50-mg droplets of the A&K composition on 11 Mar. 2005. In insecticide treatment plots, insecticide (Endosulfan plus Volt Oil) was applied on 15 Apr. 2005. Control plots received neither A&K nor insecticide applications.

To monitor population densities of Kermania pistaciella in all plots, three sticky 2-L milk carton traps (22) per 2-hectare plot were suspended from trees at a height of 1.5-2 m, 50 m apart from one another. Traps were baited with a gray sleeve stopper (23) impregnated with synthetic (2S,12Z)-2-acetoxy-12-heptadecene (50 μg). Every four days from 11 March to 18 May 2005, male Kermania pistaciella captured in each trap were recorded.

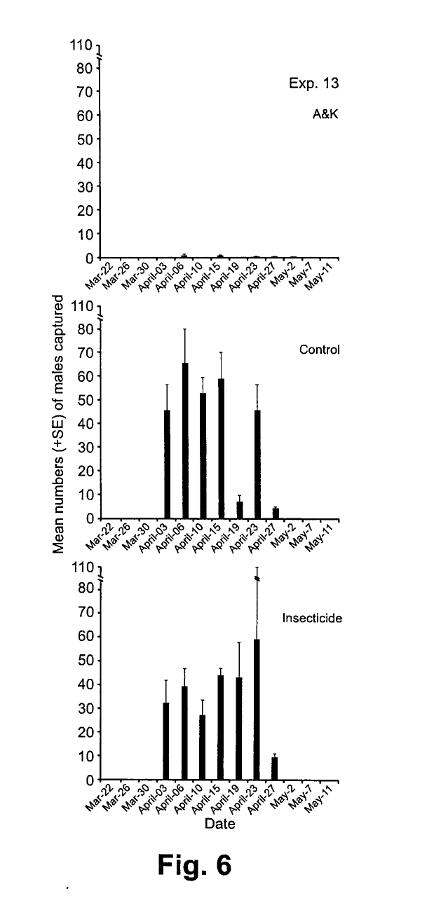

Captures of males in A&K treatment plots were significantly lower than captures in insecticide-treated or control plots (FIG. 6), suggesting that males in A&K plots contacted A&K droplets and died before they could enter traps.

FIG. 6 illustrates graphical data of captures of male Kermania pistaciella in 4-day intervals in experiment 13 (near Chatrood, Iran) in sticky traps baited with (2S,12Z)-2-acetoxy-12-heptadecene (50 μg). Each data point represents the mean number (+/−standard error) of males captured in the 15 traps (3 in each of five plots) assigned to a particular treatment (A&K, insecticide, or control).

To determine the ability of the A&K technology to reduce fruit bunch damage caused by Kermania pistaciella, damage assessments were initiated on 15 Sep. 2005 during fruit harvest. In each of the fifteen 2-hectare treatment plots, 25 trees were selected randomly in the center of each plot. All fruit bunches of each selected tree were removed, counted, checked for the presence of Kermania pistaciella larvae, and the proportion of damaged fruit bunches per tree was calculated.

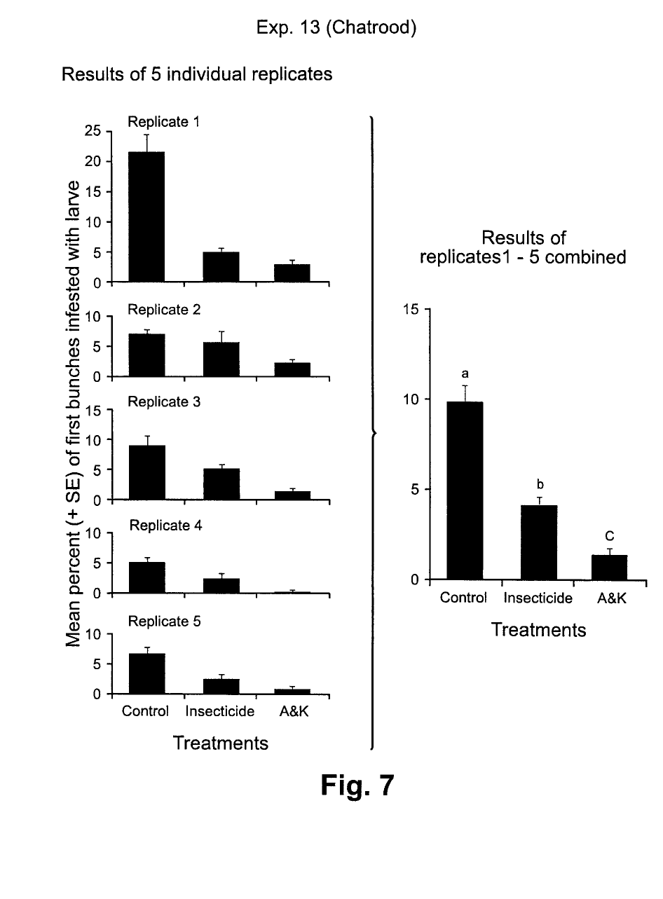

In each of all five 2-hectare A&K treatment plots, the proportions of damaged fruit bunches per tree were significantly lower than those in insecticide treatment plots or control plots (FIG. 7).

FIG. 7 illustrates graphical data of proportions of damaged fruit bunches per tree in plots treated with the A&K composition, insecticide, or left untreated. In combined results of replicates 1-5 (right side of drawing), bars with different letter superscripts are significantly different. For statistical analyses, data were transformed by arcsin and subjected to Analysis of Variance followed by the Student-Newman-Keuls test for comparison of means (24). Untransformed data are presented.

### EXAMPLE #3

Experiment 14 was conducted in commercial apple orchards near Casieu, Cluj county, Romania. Trees were 15 years old and had been planted at a density of 1200 trees per hectare, with 2-m spacing between trees and 4-m spacing between rows. The experiment had five replicates, and each replicate had two treatments, as follows: (a) application of the A&K composition (1 hectare); and (b) application of insecticide [Sumit 250 (fénitrothion) and Fyfanon 50EC (malathion)] (1 hectare). The A&K composition contained 0.2% of synthetic (E,E)-8,10-dodecadien-1-ol, the sex pheromone of codling moth, Cydia pomonella. In A&K treatment plots, each tree received two to four widely-spaced 50-mg droplets of the A&K composition. The first A&K application took place between 27 April to 5 May 2005, and the second application between 1-7 Jul. 2005. In insecticide treatment plots, insecticide was applied between 29 Apr. and 7 May 2005, and between 4 and 11 Jul. 2005.

To monitor population densities of Cydia pomonella in all ten 1-hectare plots, two sticky 2-L milk carton traps (22) per plot were suspended from trees at a height of 1.5-2 m and spaced x m apart. Traps were baited with a gray sleeve stopper (23) impregnated with synthetic (E,E)-8,10-dodecadien-1-ol (50 μg). Every two to three days, male Cydia pomonella captured in each trap were recorded.

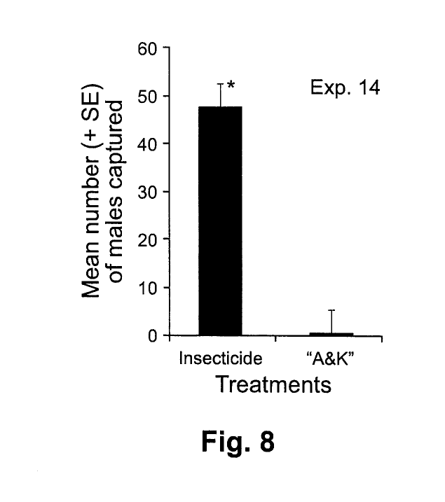

Captures of males in A&K treatment plots were significantly lower than captures in insecticide-treated plots (FIG. 8), suggesting that males in A&K plots contacted A&K droplets and died before they could enter traps.

FIG. 8 illustrates graphical data of captures of male Cydia pomonella in experiment 14 in sticky traps baited with synthetic (E,E)-8,10-dodecadien-1-ol (50 μg). Commercial apple orchard near Caseiu, Cluj county, Romania; five 2-trap replicates. The asterisk (*) indicates significantly higher captures in plots treated with insecticide; t-test (24), P<0.05.

To determine the ability of the A&K technology to reduce the incidence of apples infested with larvae of Cydia pomonella, assessments were conducted between 2 and 9 Sep. 2005. In each of the ten 1-hectare plots, trees were selected from the center of the plot. Each selected tree was then divided into four quadrants (north, south, east, west), and one quadrant was sampled for damage incidence. Sampling started in the top of that quadrant and from the top of branches. When either 100 apples per quadrant per tree, or all apples from that quadrant, had been checked for the presence of damage, sampling resumed in a new quadrant (clockwise rotation) of a new tree. This method proceeded until 1000 apples per plot had been checked.

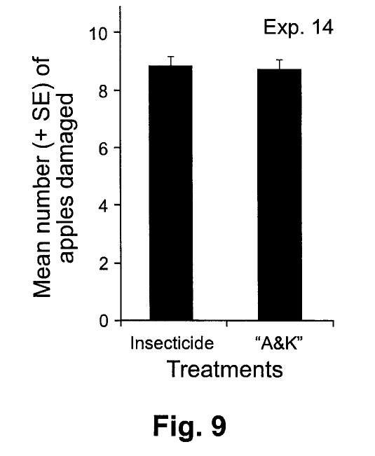

The mean proportion of damaged apples in A&K treatment plots was very similar to that in insecticide-treated plots (FIG. 9), suggesting that the A&K and insecticide treatments were equally effective in reducing the proportion of apples with a Cydia pomonella larva.

FIG. 9 illustrates graphical data of the mean proportion of apples damaged by Cydia pomonella larvae in five 1-hectare plots treated with insecticide or the A&K composition. Apple orchard near Caseiu, Cluj county, Romania. The mean proportion of damaged apples in both treatments was not statistically different; t-test, P>0.05.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

### REFERENCES AND NOTES

1. Cardé, R. T., Baker, T. C. & Castrovillo, P. J. 1977. Disruption of sexual communication in Laspeyresia pomonella (codling moth), Grapholitha molesta (oriental fruit moth) and G. prunivora (lesser appleworm) with hollow fibre attractant sources. Entomologia Experimentalis et Applicata 22: 280-288.
2. Moffitt, H. R. & Westigard, P. H. 1984. Suppression of the codling moth (Lepidoptera: Tortricidae) population on pears in southern Oregon through mating disruption with sex pheromone. Journal of Economic Entomology 77: 1513-1519.
3. Thorpe, K. W., Mastro, V. C., Leonard, D. S., Leonhardt, B. A., McLane, W., Reardon, R. C. & Talley, S. E. 1998. Comparative efficacy of two controlled-release gyspsy moth mating disruption formulations. Entomologia Experimentalis et Applicata 90:267-277.
4. Charmillot, P. J. & Pasquier, D. 1992. Lutte par confusion contre le carpocapse Cydia pomonella L. Revue Suisse de viticulture arboriculture horticulture 24: 213-220.
5. Taschenberg, E. F. & Roelofs, W. L. 1976. Pheromone communication disruption of the grape berry moth with microencapsulated and hollow fiber systems. Environmental Entomology 5:688-691.
6. Hall, D. R. & Marrs, G. J. 1989. Microcapsules. In: Jutsum A. R. & Gordon R. F. S. (eds.), Insect Pheromones in Plant Protection. John Wiley and Sons Ltd., New York, pp. 199-248.
7. Charmillot, P. J. & Pasquier, D. 2001. Essai préliminaire de lutte par confusion contre la cochylis Eupoecillia ambiguella et le carpocapse Cydia pomonella au moyen des microcapsules 3M. IOBC wprs Bulletin 24: 63-64.
8. Trimble, R. M., Vickers, P. M., Nielsen, K. E. & Barinshteyn, G. 2003. Sprayable pheromone for controlling the North American grape berry moth by mating disruption. Agricultural and Forest Entomology 5:263-268.
9. Shorey, H. H. & Gerber, R. G. 1996. Use of buffers for disruption of sex pheromone communication of codling moths (Lepidoptera: Tortricidae) in walnut orchards. Environmental Entomology 25:1398-1400.
10. Baker, T. C., Mafro-Neto, A., Fadamiro, H. & Rice, M. E. 1996. A novel controlled release device for disrupting sex pheromone communication in moths. Book of abstracts. 13th Annual Meeting of the International Society of Chemical Ecology. August 18-22. Prague. Czech Republic pp. 143-144.
11. Charmillot, P. J., Hofer, D. & Pasquier, D. 2000. Attract and kill: a new method for control of the codling moth Cydia pomonella. Entomologia Experimentalis et Applicata 94:211-216.
12. Losel, P., Penners, G. & Weissmuller, J. 1998. Insecticidal attract-and-kill formulations. U.S. Pat. No. 5,707,638 (Assignee: Bayer Aktiengesellschaft)
13. Angst, M., Gugumus, F., Rist, G., Vogt, M. & Rody, J. 1998. Pest Control U.S. Pat. No. 5,759,561 (Assignee Novartis Corporation).
14. Hoffer, D. & Brassel, J. 1992 “Attract and kill” to control Cydia pomonella and Pectinophora gossypiella. pp. 36-39 In Proceedings of the Working Group “Use of Pheromones and other Semiochemicals in Integrated Control”. San Michele All'Adige, Italy. IOBC Bulletin XV 5.
15. Hoffer, D. 1994. Sirene®: A new approach to pink bollworm control. Insect Control: Ciba Crop Protection Division Newsletter. 3:2-5.
16. Hoffer, D. & Angst, M. 1995a. Control of codling moth in apple with Sirene, a novel sprayable attract and kill formulation. 69th Annual Western Orchard Pest and Disease Managament Conference, Portland, Oreg.
17. Hoffer, D. & Angst, M. 1995b. Control of pink bollworm in cotton with Sirene, a novel sprayable attract and kill formulation. 1995 Beltville Cotton Conferences, San Antonio, Tex.
18. Hoffer, D., Charmillot, P. & Angst, M. 1995. Control of codling moth (Cydia pomonella) with Sirene, a novel attract and kill formulation. 20th International Congress of Entomology, Firenze, Italy.
19. Charmillot, P. J., Pasquier, D., Scalco, A. & Hofer, D. 1996. Essais de lutte contre le carpocapse Cydia pomonella L. par un procédé attracticide. Mitt. Schweiz. Entomol. Gesell. 69:431-439.
20. Charmillot, P. J. 1997. Codling moth control with Sirene® CM in the western part of Switzerland. Insecticides: Novartis Crop Protection Newsletter 1:10-11.
21. Reding, M. 1998. Attract and kill technology for the control of codling moth in Northern Utah. November 10^{th}. Entomological Society of America Annual General Meeting. Las Vegas, Nevada. November 8-12.
22. Gray, T. G., Slessor K N, Shepherd R F, Grant G G, and Manville J F. 1984. European pine shoot moth, Rhyacionia buolina (Lepidoptera: Torticidae): Identification of additional pheromone components resulting in an improved lure. The Canadian Entomologist 116:1525-1532
23. West Pharmaceutical Services, Lionville, Pa.
24. Zar, J. H. 1984. Biostatiscal Analysis, 2nd ed. Prentice Hal, Englewood Cliffs.

We claim:

1. An insecticidal attract-and-kill composition comprising:
(a) an organic biodegradable matrix component from natural sources;
(b) an organic biodegradable ultraviolet light absorbent matrix component from natural sources;
(c) a biodegradable insecticidal or acaricidal compound;
(d) a pheromonal or kairomonal attractant

2. A composition as claimed in claim 1, wherein the organic matrix component (a) is selected from the group consisting of gelled castor oil, gelled canola oil, gelled soybean oil, gelled hydrogenated vegetable oil, gelled palm oil, gelled rice bran oil, gelled sunflower oil, gelled flax seed oil, gelled hemp seed oil, gelled grape seed oil, gelled safflower oil, and any other suitable plant-derived oil.

3. A composition as claimed in claim 1, wherein the organic ultraviolet light absorbent matrix component (b) is selected from the group consisting of different grades of modified and unmodified lignins.

4. A composition as claimed in claim 1, wherein the insecticidal or acaricidal compound (c) is selected from the group consisting of biodegradable pyrethroids, carbamates, organophosphates, aliphatic derivatives, phenyl derivatives, heterocyclic derivatives, neonicotinoids, phenylpyrazoles, pyrroles, pyrazoles, pyridazinones, botanicals, and mineral oils.

5. A composition as claimed in claim 1, wherein the pheromonal or kairomonal attractant (d) is selected from the group consisting of insect, mite, spider, and tick pheromones or kairomones diluted in organic solvent.

6. A composition as claimed in claim 1, wherein the pheromonal or kairomonal attractant is diluted in an organic solvent which is selected from the group consisting of polar, non-polar, protonic, and aprotonic solvents.

7. An insecticidal attract-and-kill composition for control of the pistachio twig borer moth, Kermania pistaciella, comprising:
a) gelled castor oil (30-80% by weight) as a matrix component;
b) lignin (5-80% by weight) as a matrix component and absorbent of ultraviolet light;
c) insecticidal permethrin (0.1-10% by weight); and
d) pheromonal (2S,12Z)-2-acetoxy-12-heptadecene in organic solvent (0.1-20% by weight), the respective components and compounds totaling 100 percent.

8. An insecticidal attract-and-kill composition for control of the codling moth, Cydia pomonella, comprising:
a) gelled castor oil (30-80% by weight) as a matrix component;
b) lignin (5-80% by weight) as a matrix component and absorbent of ultraviolet light;
c) insecticidal permethrin (0.1-10% by weight);
d) pheromonal (E,E)-8,10-dodecadienol in organic solvent (0.1-20% by weight), the respective components and compounds totaling 100 percent.

9. A composition as claimed in claim 1, wherein the composition does not contain an insecticidal or an acaricidal compound (c).

10. A composition as claimed in claim 1, wherein the composition does not contain an insecticidal or an acaricidal compound (c), and instead of an attractant (d), it contains a repellent.

11. A method of controlling harmful insects, ticks, mites, spiders, or other pest arthropods by distributing in the area to be protected an effective amount of the composition, as claimed in claim 1.

12. A method as claimed in claim 11, wherein the area is an agricultural, horticultural, forestry or nursery setting.

13. A method as claimed in claim 11, wherein the area is a livestock production facility.

14. A method as claimed in claim 11, wherein the area is an urban or recreational environment.

15. A method as claimed in claim 11, which comprises applying the composition by manual or automated delivery devices.

16. A method as claimed in any of claims 11-15 wherein the composition is used in combination with other tactics for control of pest insects, arachnids or other pest arthropods.

17. The use of a composition as claimed in claim 1 in the attraction or kill of insect pests.
